(19) United States
(12) Patent Application Publication
(10) Pub. No.: US 2026/0116613 A1
(43) Pub. Date: Apr. 30, 2026

(54) TRAY WITH STACKING FEATURES

(71) Applicant: Graphic Packaging International, LLC, Atlanta, GA (US)

(72) Inventor: Lee Nowak, Leicestershire (GB)

(21) Appl. No.: 19/370,958

(22) Filed: Oct. 28, 2025

Related U.S. Application Data
(60) Provisional application No. 63/713,127, filed on Oct. 29, 2024.

(51) Int. Cl. B65D 5/00; B31B 50/26; B65D 5/20; B65D 5/28

(52) U.S. Cl. CPC B65D 5/001; B31B 50/26; B65D 5/2033; B65D 5/28

(57) ABSTRACT

A tray for holding one or more articles may include an upper construct having a plurality of upper panels, which include a flange panel extending at least partially around an opening and at least partially forming a flange of the tray. A lower construct may include a plurality of lower panels, the plurality of lower panels including a bottom panel at least partially forming a bottom wall of the tray and a plurality of lower side panels at least partially forming a sidewall around an interior of the tray. Stacking features may be defined along the flange of the tray and extend into the opening to support another tray thereon. Methods of forming the tray and combinations of blanks for forming the tray are also disclosed.

### CROSS-REFERENCE TO RELATED APPLICATION

The present application claims priority to U.S. Provisional Patent Application No. 63/713,127 filed on Oct. 29, 2024.

### INCORPORATION BY REFERENCE

The disclosure of U.S. Provisional Patent Application No. 63/713,127 which was filed on Oct. 29, 2024 is hereby incorporated by reference for all purposes as if presented herein in their entirety.

### TECHNICAL FIELD

The disclosure relates to trays formed from blanks that are designed for storing or serving articles. In particular, the disclosure concerns trays incorporating stacking features for improved storage and handling.

### BACKGROUND OF THE DISCLOSURE

The present disclosure relates to blanks, containers, trays, constructs, and various features and methods for forming a container from a blank. More specifically, the disclosure is generally directed to trays with stacking features.

### SUMMARY OF THE DISCLOSURE

In some embodiments, a tray for holding one or more articles may comprise an upper construct comprising a plurality of upper panels. The plurality of upper panels may comprise a flange panel extending at least partially around an opening and at least partially forming a flange of the tray. The tray may comprise a lower construct comprising a plurality of lower panels. The plurality of lower panels may comprise a bottom panel at least partially forming a bottom wall of the tray and a plurality of lower side panels at least partially forming a sidewall extending at least partially around an interior of the tray. The tray may comprise stacking features at least partially defined along the flange of the tray and extending into the opening for supporting another tray thereon.

In some embodiments, the stacking features may include a first, a second and a third stacking feature. In various embodiments, the plurality of upper panels may include a plurality of upper side panels foldably connected to the flange panel and the plurality of lower side panels may be foldably connected to the bottom wall. In some embodiments, at least some of the plurality of lower panels may cooperate with at least some of the plurality of upper side panels to form the sidewall. In various embodiments, a first stacking feature may be formed by two second side lower side panels, an upper side panel, and a free edge of the flange panel. In some embodiments, each of the second and third stacking features may be formed by two first side lower side panels and an upper side panel end flap. In various embodiments, the bottom panel and the sidewall may cooperate to define an interior surface of the tray and the sidewall may cooperate with the flange panel to define the stacking features. In some embodiments, each stacking feature may include a protuberance extending at least partially along the interior surface of the tray. In various embodiments, the plurality of upper side panels may extend at an oblique angle from the flange panel and the plurality of lower side panels may extend at an oblique angle from the bottom wall.

In some embodiments, a combination of blanks for forming a tray may comprise an upper blank comprising a plurality of upper panels. The plurality of upper panels may comprise a flange panel extending at least partially around an opening and at least partially forming a flange of the tray. The combination of blanks may comprise a lower blank comprising a plurality of lower panels. The plurality of lower panels may comprise a bottom panel configured to at least partially form a bottom wall of the tray and a plurality of lower side panels configured to at least partially form a sidewall extending at least partially around an interior of the tray. The combination of blanks may comprise stacking features at least partially defined along the flange of the tray and extending into the opening for supporting another tray thereon.

In some embodiments, the stacking features may comprise a first, a second and a third stacking feature. In various embodiments, the plurality of upper panels may include a plurality of upper side panels foldably connected to the flange panel and the plurality of lower side panels may be foldably connected to the bottom wall. In some embodiments, at least some of the plurality of lower side panels may be configured to cooperate with at least some of the plurality of upper side panels to form the sidewall. In various embodiments, a first stacking feature may be formed by two second side lower side panels, an upper side panel, and a free edge of flange panel. In some embodiments, each of the second and third stacking features may be formed by two first side lower side panels and an upper side panel end flap. In various embodiments, the bottom panel and the sidewall may be configured to cooperate to define an interior surface of the tray and the sidewall may be configured to cooperate with the flange panel to form the stacking features. In some embodiments, each stacking feature may include a protuberance extending at least partially along the interior surface of the tray. In various embodiments, the plurality of upper side panels may be configured to extend at an oblique angle from the flange panel and the plurality of lower side panels may be configured to extend at an oblique angle from the bottom wall.

In some embodiments, a method of forming a tray may comprise obtaining an upper blank comprising a plurality of upper panels. The plurality of upper panels may comprise a flange panel extending at least partially around an opening and stacking features extending into the opening. The method may comprise obtaining a lower blank comprising a plurality of lower panels that comprise a bottom panel and a plurality of lower side panels. The method may comprise forming an upper construct from the upper blank to form a flange of the tray and forming a lower construct from the lower blank such that the bottom panel at least partially forms a bottom wall of the tray and such that the plurality of lower side panels at least partially form a sidewall of the tray, and such that the stacking features are arranged along the flange of the tray for at least partially supporting another tray thereon.

In some embodiments, the stacking features may include a first, a second and a third stacking feature. In various embodiments, the plurality of upper panels may include a plurality of upper side panels foldably connected to the flange panel and the plurality of lower side panels may be foldably connected to the bottom wall. In some embodiments, at least some of the plurality of lower side panels may cooperate with at least some of the plurality of upper side panels to form the sidewall. In various embodiments, each of the second and third stacking features may be formed by two first side lower side panels and an upper side panel end flap. In some embodiments, the bottom panel and the sidewall may cooperate to define an interior surface of the tray and the sidewall may cooperate with the flange panel to define the stacking features. In various embodiments, each stacking feature may include a protuberance extending at least partially along the interior surface of the tray. In some embodiments, the plurality of upper side panels may extend at an oblique angle from the flange panel and the plurality of lower side panels may extend at an oblique angle from the bottom wall.

In some embodiments, a stack of trays for holding one or more food products may comprise an upper tray. The stack of trays may comprise a lower tray at least partially supporting the upper tray. The lower tray may comprise an upper construct comprising a plurality of upper panels. The plurality of upper panels may comprise a flange panel extending at least partially around an opening and at least partially forming a flange of the lower tray. The lower tray may comprise a lower construct comprising a plurality of lower panels comprising a bottom panel at least partially forming a bottom wall of the lower tray and a plurality of lower side panels at least partially forming a sidewall extending at least partially around an interior of the lower tray. The lower tray may comprise stacking features at least partially defined along the flange of the tray and extending into the opening for at least partially supporting the upper tray.

In some embodiments, the stacking features may include a first stacking feature, a second stacking feature, and a third stacking feature. In various embodiments, the plurality of upper panels may include a plurality of upper side panels foldably connected to the flange panel and the plurality of lower side panels may be foldably connected to the bottom wall. In some embodiments, at least some of the plurality of lower side panels may cooperate with at least some of the plurality of upper side panels to form the sidewall. In various embodiments, a first stacking feature may be formed by two second side lower side panels, an upper side panel, and a free edge of flange panel. In some embodiments, each of the second and third stacking features may be formed by two first side lower side panels and an upper side panel end flap. In various embodiments, the bottom panel and the sidewall may cooperate to define an interior surface of the lower tray and the sidewall may cooperate with the flange panel to define the stacking features.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of a first blank for at least partially forming a tray according to an embodiment of the disclosure.

FIG. 2 is a plan view of a second blank for at least partially forming a tray according to an embodiment of the disclosure.

FIGS. 3-18 are views of a tray formed from the blanks of FIGS. 1 and 2 according to an embodiment of the present disclosure.

FIGS. 19-21 are views of multiple trays of the type of FIGS. 3-18 in nested configurations.

FIGS. 22-26 are views of multiple trays of the type of FIGS. 3-18 in stacked configurations.

FIGS. 27-28 are additional views of trays of the type of FIGS. 3-18.

FIG. 29 is a perspective view of a tray of the type of FIGS. 3-18 provided with a lidding film.

FIG. 30 is a perspective view of a tray of the type of FIGS. 3-18 provided with a liner.

FIG. 31 is a schematic view of an apparatus for processing a blank and/or tray that can be used with embodiments of the disclosure.

Corresponding parts are designated by corresponding reference numbers throughout the drawings.

### DETAILED DESCRIPTION

The present disclosure relates generally to various aspects of containers, constructs, trays, materials, packages, elements, and articles, and methods of making such containers, constructs, trays, materials, packages, elements, and articles. Although several different aspects, implementations, and embodiments are disclosed, numerous interrelationships between, combinations thereof, and modifications of the various aspects, implementations, and embodiments are contemplated hereby. In one illustrated embodiment, the present disclosure relates to forming a container or tray for holding food items or various other articles. However, in other embodiments, the container or tray can be used to form other non-food containing articles or may be used for heating or cooking.

Trays described herein can be used for holding one or more articles such as food products, e.g., portioned retail food products that can include one or more of cookies, crackers, cakes, pastries, candies, nuts, popcorn, trail mix, gum, etc. In some embodiments, the articles can include frozen or non-frozen food products that can be provided in discrete portions, for example, chicken nuggets, French fries, onion rings, mozzarella sticks, chips, popcorn, other finger foods, etc. In embodiments, other types of articles that can include food products and/or non-food products can be placed in the tray for service to a customer. In some embodiments, such products can be contained in additional packaging and then placed in the tray.

The disclosed technology provides a stackable food service tray system that addresses common challenges in commercial food operations through an innovative dual-construct design. The system may comprise two separate blanks that may be assembled to form a tray with integrated stacking features, enabling both space-efficient storage and stable display configurations.

The tray system may operate through a unique combination of upper and lower constructs that may be formed from separate blanks and assembled into a unified structure. The lower construct may form the primary containment structure with a bottom panel and sidewalls, while the upper construct may provide a flange assembly with specialized stacking features. These stacking features may extend into the central opening of the flange, creating protruding portions that may support additional trays when stacked in an inverted orientation. The dual-construct approach may allow the tray to function in multiple configurations, including nested arrangements for storage and stacked arrangements for service applications.

The stacking capability may be achieved through asymmetrical flange geometry that may enable trays to be rotated approximately 180 degrees relative to each other for stable stacking. When positioned in this inverted orientation, the bottom wall of an upper tray may rest upon the stacking features of a lower tray, creating a secure stacking arrangement that may avoid placing stress on optional lidding films. The system may also accommodate nesting of empty trays by engaging complementary protruding and recessed portions of the sidewalls, allowing multiple trays to be compactly arranged for shipping and storage. Optional features may include thermoplastic liners for leak resistance and lidding films for hermetic sealing, expanding the versatility of the tray system for various food service applications.

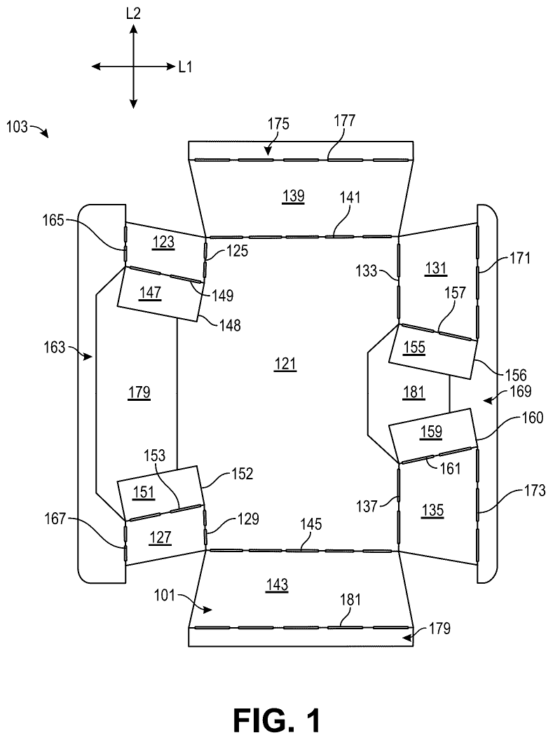

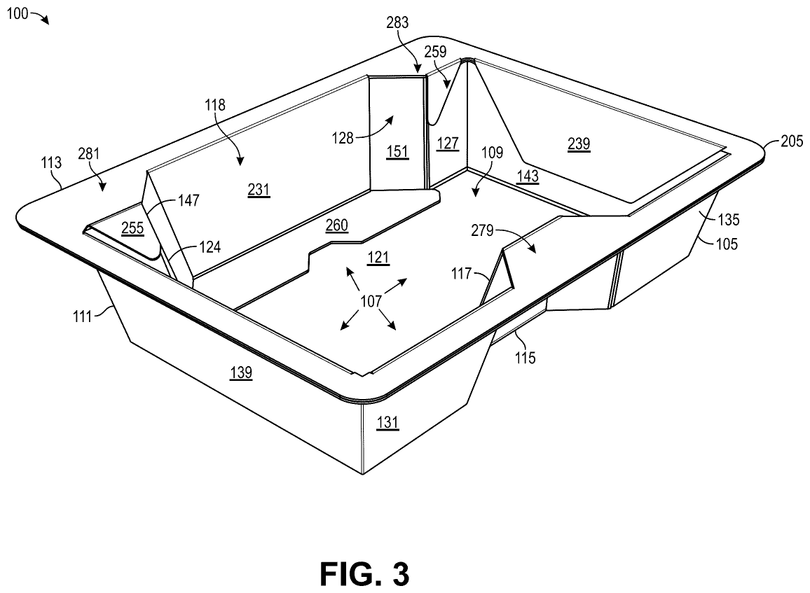

FIG. 1 illustrates an exterior surface 101 of a base blank or lower blank or first blank 103 for at least partially forming a tray 100 (FIG. 3) or other container according to exemplary embodiments of the disclosure. As described further herein, the first blank 103 can be for forming a lower construct 105 of the tray 100.

In the illustrated embodiment, the lower blank 103 can have a longitudinal axis L1, a lateral axis L2, and a plurality of panels for extending at least partially around an interior 107 of the tray 100.

The plurality of panels of the lower blank 103 can include a central panel or bottom panel 121, a first side lower side panel 123 (broadly, “second side lower side panel”) foldably connected to the bottom panel 121 at a lateral fold line 125, a first side lower side panel 127 (broadly, “second side lower side panel”) foldably connected to the bottom panel 121 at a lateral fold line 129, a second side lower side panel 131 (broadly, “first side lower side panel”) foldably connected to the bottom panel 121 at a lateral fold line 133, and a second side lower side panel 135 (broadly, “first side lower side panel”) foldably connected to the bottom panel at a lateral fold line 137.

Another first side lower side panel 147 (broadly, “second side lower side panel”) can be foldably connected to the lower side panel 123 at an oblique fold line 149, a first side lower side panel 151 (broadly, “second side lower side panel”) can be foldably connected to the lower side panel 127 at an oblique fold line 153, a second side lower side panel 155 (broadly, “first side lower side panel”) can be foldably connected to the lower side panel 131 at an oblique fold line 157, and a second side lower side panel 159 (broadly, “first side lower side panel”) can be foldably connected to the lower side panel 135 at an oblique fold line 161. In the illustrated embodiment, the lower side panels 147, 151 can be at least partially separable from the bottom panel 121 at respective oblique cuts 148, 152.

The plurality of panels can further include a first lower end panel 139 (broadly, “second lower end panel”) foldably connected to the bottom panel 121 at a longitudinal fold line 141, and a second lower end panel 143 (broadly, “first lower end panel”) foldably connected to the bottom panel 121 at a longitudinal fold line 145.

A plurality of end flaps can also be foldably connected to a respective panel of the plurality of panels of the lower blank 103/lower construct 105. The plurality of end flaps can include a first side lower top end flap 163 (broadly, “second side lower top end flap”) foldably connected to the lower side panel 123 at a lateral fold line 165 and foldably connected to the lower side panel 127 at a lateral fold line 167. A second side lower top end flap 169 (broadly, “first side lower top end flap”) can be foldably connected to the lower side panel 131 at a lateral fold line 171 and can be foldably connected to the lower side panel 135 at a lateral fold line 173.

As shown, the lower side panel 155 can be at least partially separable from the lower top end flap 169 at a generally v-shaped or check-shaped cut 156 formed by intersecting oblique segments, and the lower side panel 159 can be at least partially separable from the lower top end flap 169 at a generally v-shaped or check-shaped cut 160.

With continued reference to FIG. 1, a first end lower top end flap 175 (broadly, “second end lower top end flap”) can be foldably connected to the lower end panel 139 at a lateral fold line 177, and a second end lower top end flap 179 (broadly, “first end lower top end flap”) can be foldably connected to the lower end panel 143 at a lateral fold line 181.

In the illustrated embodiment, a cutout 179 can be at least partially positioned between the bottom panel 121, the top end flap 163, and the lower side panels 123, 127 such that the lower side panels 147, 151 extend at least partially into the cutout 179.

Similarly, a cutout 181 can be at least partially positioned between the bottom panel 121, the top end flap 169, and the lower side panels 131, 135 such that the lower side panels 155, 159 extend at least partially into the cutout 181.

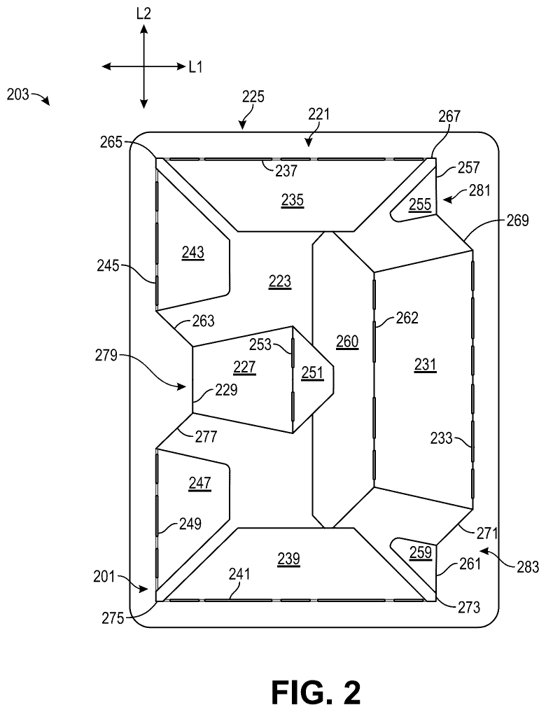

Turning to FIG. 2, the exterior surface 201 of a rim blank or upper blank or second blank 203 for at least partially forming the tray 100 is illustrated. As described further herein, the second blank 203 can be for forming an upper construct 205 of the tray 100.

As shown, the blank 203 can have the longitudinal axis L1, the lateral axis L2, and can include a plurality of panels for at least partially extending around the interior 107 of the tray 100.

The plurality of panels of the blank 203 can include a central panel or upper panel or flange panel 221 at least partially circumscribing a central opening 223. In the illustrated embodiment, the flange panel 221 can have a generally rounded rectangular outer free edge 225 and a plurality of interior free edges and fold lines that at least partially define the opening 223, as described further herein.

The plurality of panels 203 of the blank 203 and the upper construct 205 formed therefrom can include a first upper side panel 227 (broadly, “second upper side panel”) foldably connected to the flange panel 221 at a lateral fold line 229 and a second upper side panel 231 (broadly, “first upper side panel”) foldably connected to the flange panel 221 at a lateral fold line 233.

A plurality of end flaps can be foldably connected to a respective panel of the plurality of panels of the upper blank 203 and upper construct 205 formed therefrom. In the illustrated embodiment, a first upper end attachment end flap 235 (broadly, “second upper end attachment end flap”) foldably connected to the flange panel 221 at a longitudinal fold line 237, and a second upper end attachment end flap 239 (broadly, “first upper end attachment end flap”) foldably connected to the flange panel 221 at a longitudinal fold line 241.

A first side first attachment end flap 243 (broadly, “second side first attachment end flap”) can be foldably connected to the flange panel 221 at a lateral fold line 245, a first side second attachment end flap 247 (broadly, “second side second attachment end flap”) can be foldably connected to the flange panel 221 at a lateral fold line 249, and a first bottom attachment end flap 251 (broadly, “second bottom attachment end flap”) can be foldably connected to the upper side panel 227 at a lateral fold line 253.

Similarly, a second side first attachment end flap 255 (broadly, “first side first attachment end flap”) can be foldably connected to the flange panel 221 at a lateral fold line 257, a second side second attachment end flap 259 (broadly, “first side second attachment end flap”) can be foldably connected to the flange panel 221 at a lateral fold line 261, and a second bottom attachment end flap 260 (broadly, “first bottom attachment end flap”) can be foldably connected to the upper side panel 231 at a lateral fold line 262.

In the aforementioned arrangement, the panels 227, 231 and the end flaps 235, 239, 243, 247, 251, 255, 259 can be positioned extending at least partially into the cutout 223, and can be movable into the cutout 223 (e.g., into the page from the perspective of FIG. 2) in the course of formation of the upper construct 205 from the blank 203. In this regard, the cutout 223 can be at least partially defined along the flange panel 221 by, in clockwise fashion, the fold line 229, an oblique inner free edge 263 of the flange panel 221, the fold line 245, a right angled inner free edge 265 of the flange panel 221, the fold line 237, a right angled inner free edge 267 of the flange panel 221, the fold line 257, an oblique inner free edge 269 of the flange panel 221, the fold line 233, an oblique inner free edge 271 of the flange panel 221, the fold line 261, a right angled inner free edge 273 of the flange panel 221, the fold line 241, a right angled inner free edge of 275 of the flange panel 221, the fold line 249, and an inner oblique free edge 277 of the flange panel 221.

The blank 203 and the upper construct 205/tray 100 at least partially formed therefrom can include stacking features that can include a first stacking feature 279 (broadly, “second stacking feature”, “third stacking feature”) at least partially defined by the free edges 263, 277 of the flange panel 221 so as to form a portion of the flange panel 221 that protrudes relative to adjacent portions thereof into the opening 223 for at least partially supporting another tray 100 or another structure, as described further herein.

The oblique angles referenced in the tray construction may be defined by specific angular relationships between the panels and their respective fold lines. In the illustrated embodiment, the oblique fold lines 149, 153, 157, and 161 may establish angular orientations that deviate from perpendicular relationships with adjacent panels. The oblique angle may be characterized as an angle that may be greater than 0 degrees and less than 90 degrees, or alternatively greater than 90 degrees and less than 180 degrees, as measured from a reference line extending parallel to the longitudinal axis L1 or lateral axis L2.

In some embodiments, the oblique angles may range from approximately 30 degrees to approximately 60 degrees relative to the respective fold lines 125, 129, 133, and 137. The lower side panels 147, 151, 155, and 159 may extend at oblique angles that may be within a range of approximately 35 degrees to approximately 55 degrees from the perpendicular orientation relative to the bottom panel 121. Such angular measurements may facilitate the formation of the recessed and protruding portions 115, 117, 118, 119, 122, 124, 126, and 128 of the sidewall 111.

The upper side panels may extend at oblique angles that may be measured relative to the flange panel 221. These oblique angles may range from approximately 45 degrees to approximately 75 degrees from the horizontal plane defined by the flange panel 221. In some embodiments, the oblique angles may be approximately 60 degrees, providing structural stability while enabling the formation of the stacking features 279, 281, and 283.

The lower side panels may extend at oblique angles that may be measured relative to the bottom panel 121. These oblique angles may range from approximately 45 degrees to approximately 75 degrees from the horizontal plane defined by the bottom panel 121. In some embodiments, the oblique angles may be approximately 60 degrees, providing structural stability while enabling the formation of the stacking features 279, 281, and 283.

The oblique cuts 148 and 152 may be oriented at angles that may range from approximately 20 degrees to approximately 70 degrees relative to the longitudinal axis L1. The v-shaped cuts 156 and 160 may define oblique segments that may intersect at angles ranging from approximately 90 degrees to approximately 150 degrees, with each individual segment extending at oblique angles of approximately 30 degrees to approximately 60 degrees relative to the lateral fold lines 171 and 173.

The oblique inner free edges 263, 269, 271, and 277 of the flange panel 221 may be oriented at angles that may range from approximately 15 degrees to approximately 45 degrees relative to the respective fold lines 229, 233, 245, 249, 257, and 261. These oblique orientations may contribute to the asymmetrical configuration of the opening 223 and may facilitate the formation of the stacking features that extend into the opening for supporting another tray thereon.

Similarly, at least a portion of the free edge 267, the fold line 257, and the free edge 269 of the flange panel 221 can at least partially define a second stacking feature 281 (broadly, “first stacking feature”, “third stacking feature”) protruding relative to adjacent portions of the flange panel 221 into the opening 223 for at least partially supporting another tray 100 or another structure thereupon, as described further herein.

Further, the free edge 271, the fold line 261, and at least a portion of the free edge 269 of the flange panel 221 can at least partially define a third stacking feature 283 (broadly, “first stacking feature”, “second stacking feature”) protruding relative to adjacent portions of the flange panel 221 into the opening 223 for at least partially supporting another tray 100 or another structure thereupon, as described further herein.

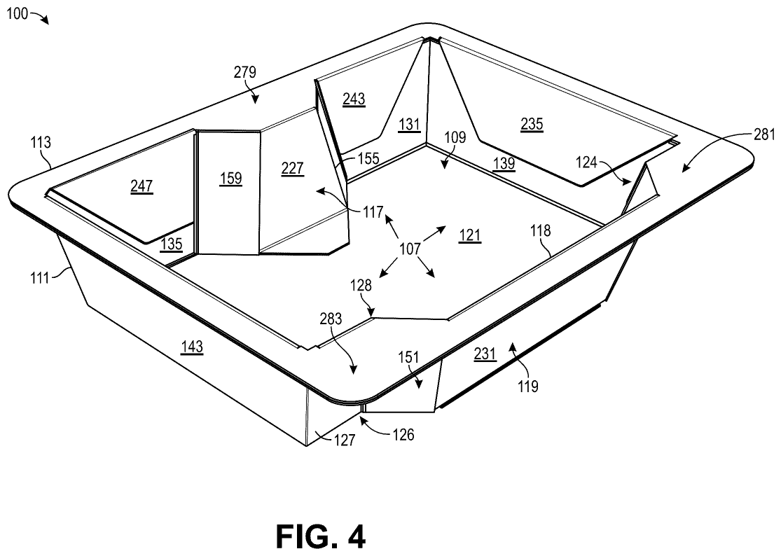

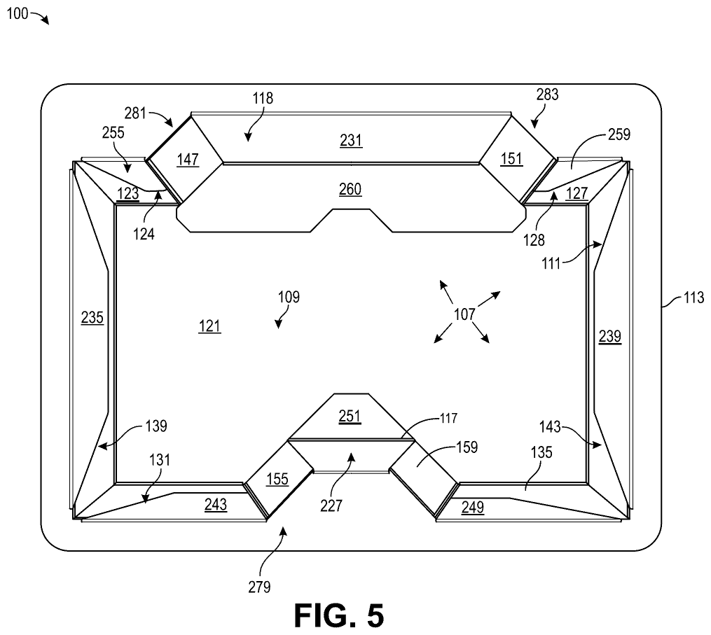

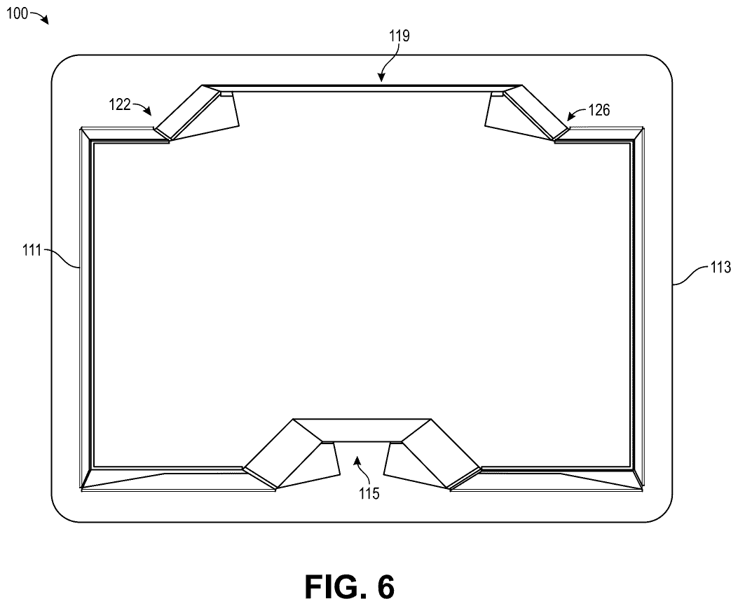

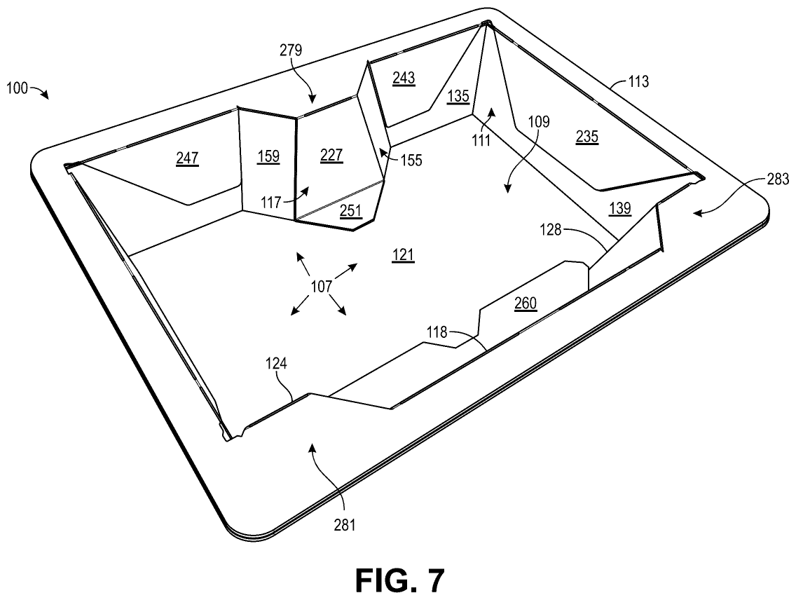

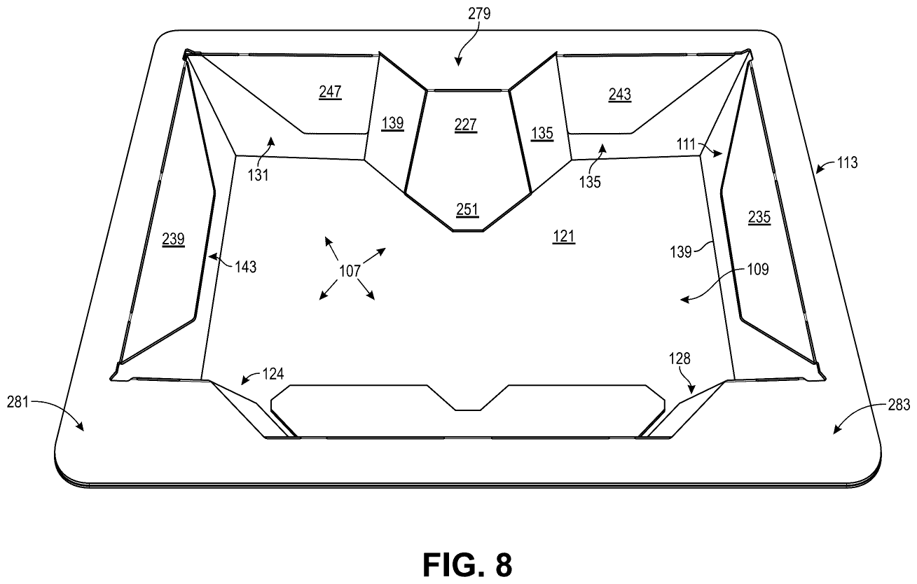

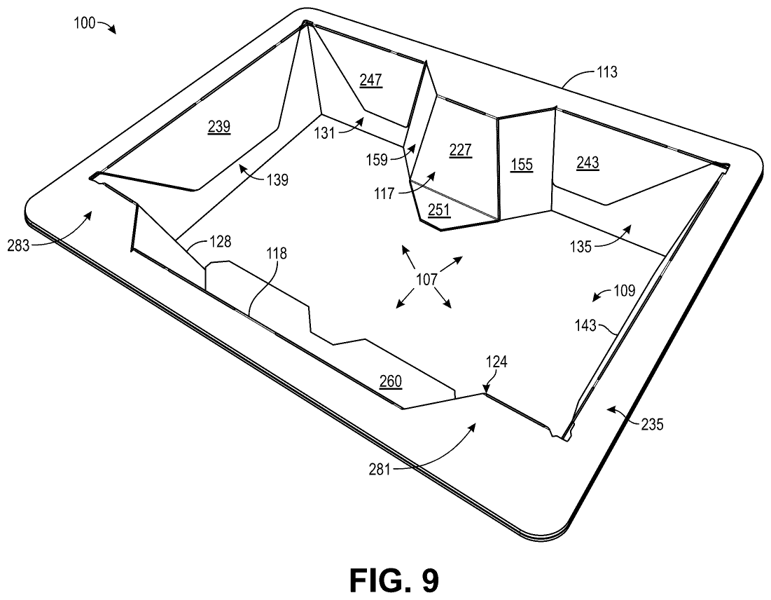

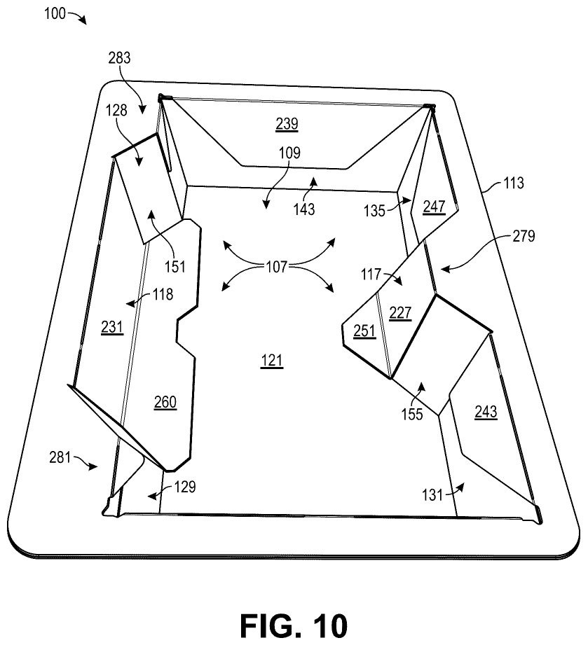

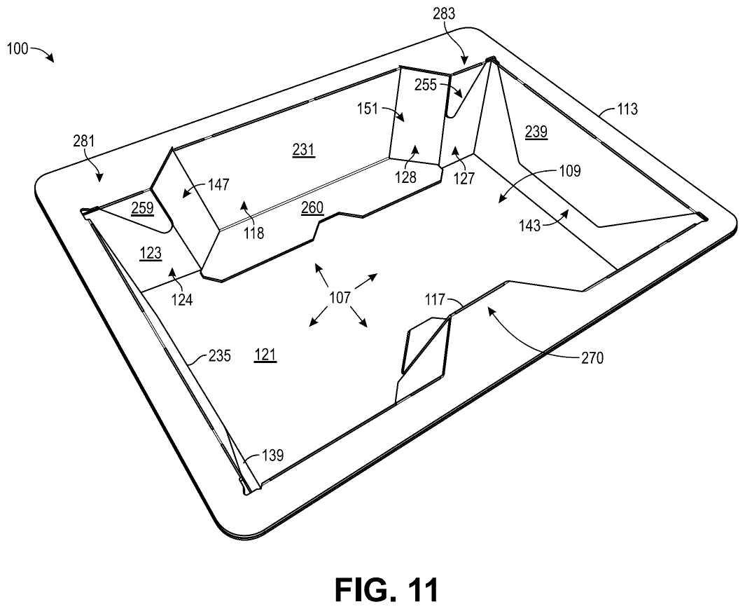

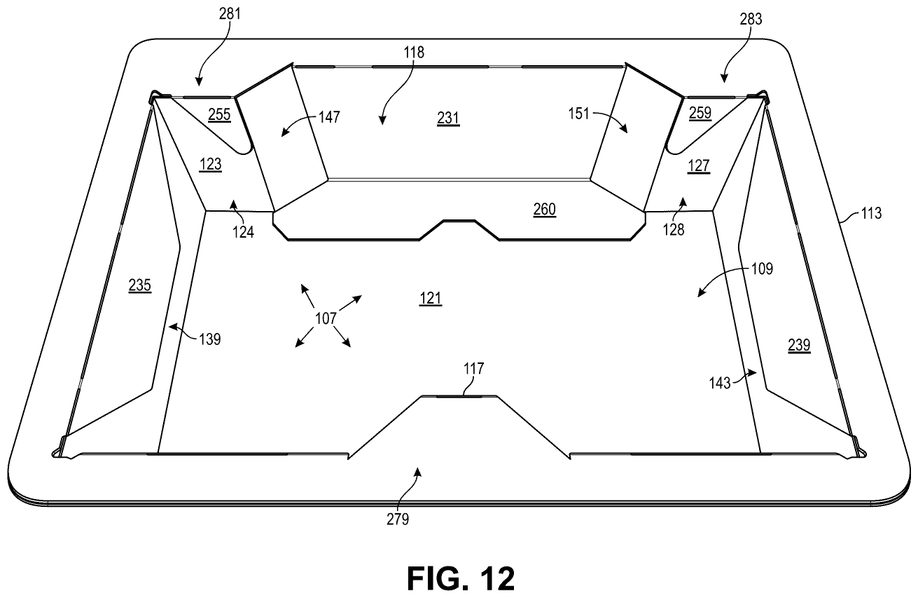

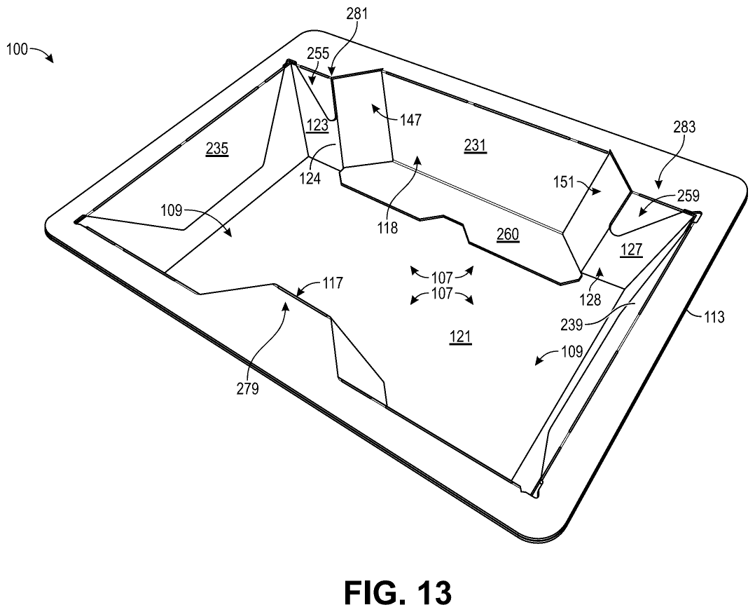

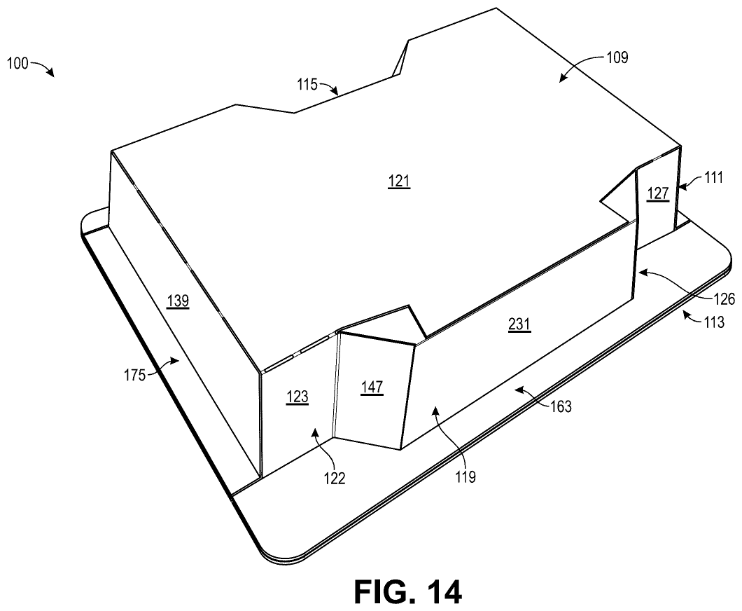

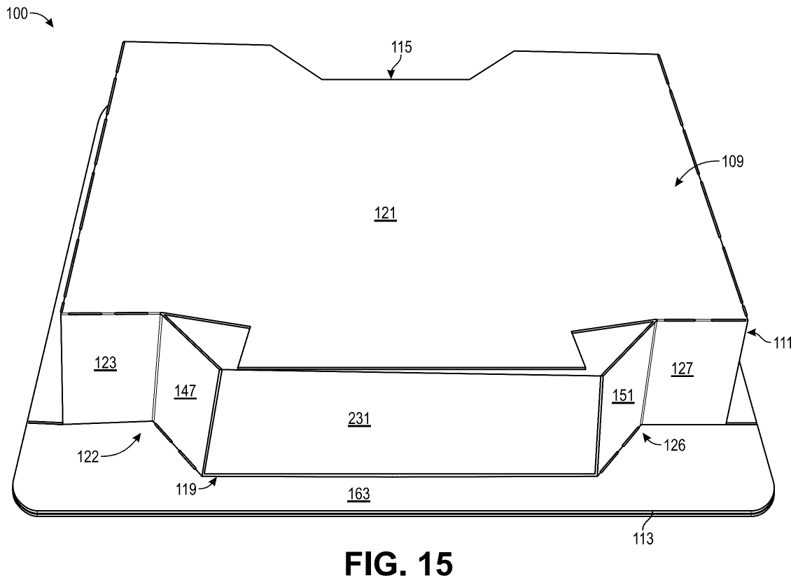

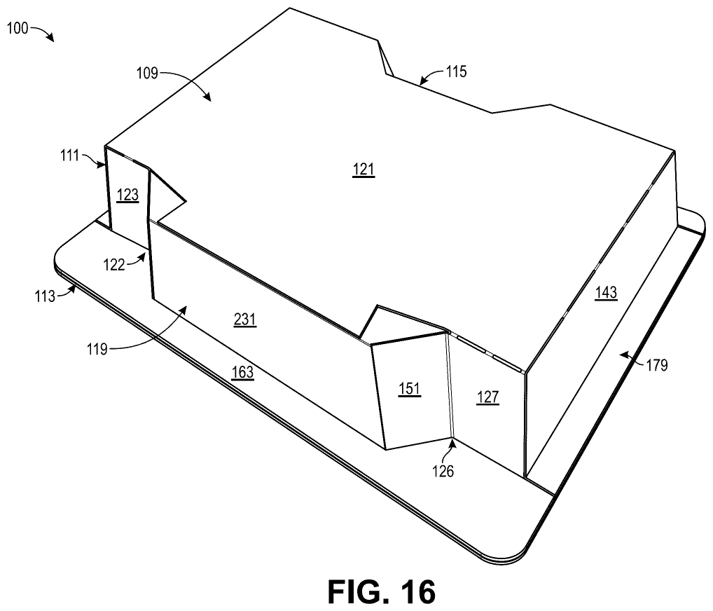

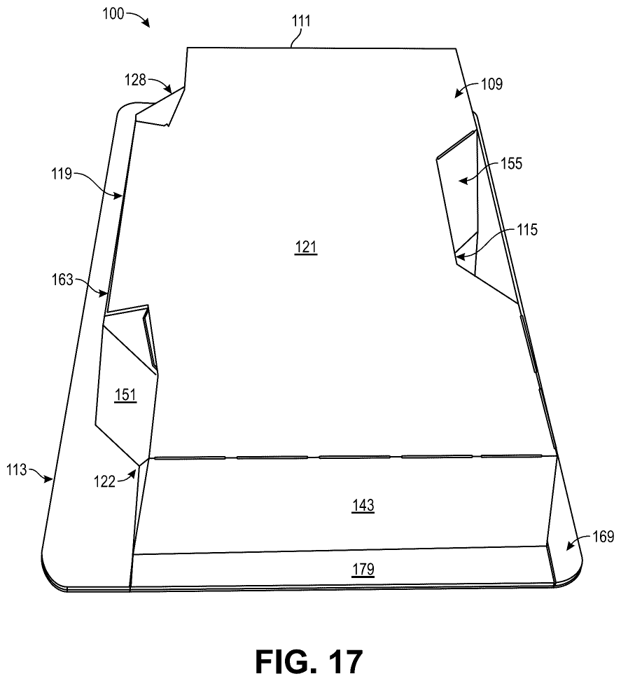

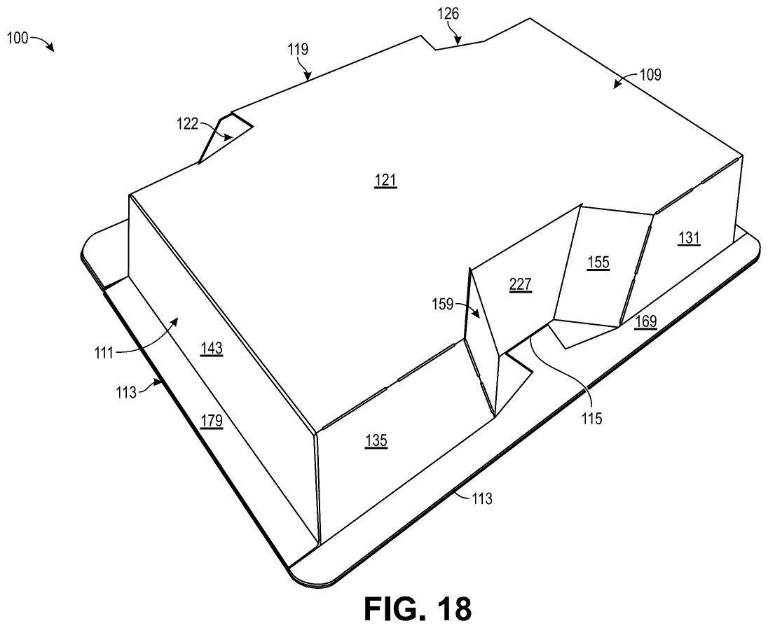

With additional reference to FIGS. 3-18, formation of the tray 100 from the blanks 103, 203, will be described according to an embodiment of the disclosure.

As shown, the exterior surface of the blank 103 can be positioned on a supporting surface and the panels 123, 127, 131, 135 can be at least partially folded at the respective fold lines 125, 129, 133, 137 to extend upwardly from the bottom panel 121. Similarly, the end panel 139 can be folded at the fold line 141 into generally upright relation with respect to the bottom panel 121, and the end panel 143 can be folded at the fold line 145 into generally upright relation with respect to the bottom panel 121. In some embodiments, the panels 123, 135, 131, 127, 139, 143 can extend in generally perpendicular relation to the bottom panel 121, and in some embodiments, one or more of the panels 123, 127, 131, 135, 139, 143 can be obliquely disposed relative to the bottom panel 121.

In some embodiments, the lower side panel 147 can be at least partially separated from the bottom panel 121 at the cut 148 and at least partially folded at the fold line 149 into oblique relation with the lower side panel 123. Similarly, the lower side panel 151 can be at least partially separated from the bottom panel 121 at the cut 152 and at least partially folded at the fold line 153 into oblique relation with the lower side panel 127.

Further, the lower side panel 155 can be at least partially folded at the fold line 157 into oblique relation with the lower side panel 131, and the lower side panel 159 can be at least partially folded at the fold line 161 into oblique relation with the lower side panel 135. It will be understood that such movement can be accompanied by at least partial separation of the lower side panels 155, 159 from the top end flap 169 at the respective cuts 156, 160.

In addition, the top end flap 163 can be folded at the respective fold lines 165, 167 into generally outward relation, e.g., generally perpendicular or oblique relation extending away therefrom, with respective to the lower side panels 123, 127. Similarly, the top end flap 169 can be folded at the respective fold lines 171, 173 into generally outward relation with respective to the lower side panels 131, 135.

The foregoing can be an example sequence for forming the lower construct 105 from the blank 103, though it will be understood that the upper construct 105 can be formed in a different sequence and/or configuration without departing from the disclosure.

The panels 227 and 231 of the blank 203 can be folded at least partially downwardly relative to the flange panel 221 at the respective fold lines 229, 233 into generally perpendicular relation with or obliquely-downwardly extending relation with the flange panel 221.

Similarly, the attachment end flaps 235, 239, 243, 247, 255, 259 can be folded at least partially downwardly relative to the flange panel 221 at the respective fold lines 237, 241, 245, 249, 257, 261 into generally perpendicular relation with or obliquely-downwardly extending relation with the flange panel 221.

In some embodiments, the attachment end flap 251 can be at least partially folded at the fold line 253 into oblique or perpendicular relation with the upper side panel 227, and the attachment end flap 260 can be at least partially folded at the fold line 262 into oblique or perpendicular relation with the upper side panel 231.

The foregoing can be an example sequence for forming the upper construct 205 from the blank 203, though it will be understood that the upper construct 205 can be formed in a different sequence and/or configuration without departing from the disclosure.

Further formation of the tray 100 can include coupling the upper construct 105 to the lower construct 205. With continued reference to FIGS. 3-18, the upper construct 205 can be positioned such that the interior surface or lower surface of the flange panel 221 is in at least partial face-to-face contact with respective portions of the top end flaps 163, 169, 175, 179 of the lower construct 105.

In such an arrangement, the side panel 231 of the upper construct 205 can be positioned between the side panels 147, 151 of the lower construct 105, and the attachment end flap 259 can be positioned in at least partial face-to-face contact with lower side panel 123. In some embodiments, the upper side panel 231 can be positioned in generally abutting edge-to-edge contact with the respective lower side panels 147, 151, and in some embodiments, the upper side panel 231 can at least partially overlap one or both of the lower side panels 147, 151.

Similarly, the side panel 227 of the upper construct 205 can be positioned between the side panels 155, 159 of the lower construct 105. In some embodiments, the upper side panel 227 can be positioned in generally abutting edge-to-edge contact with the respective lower side panels 155, 159, and in some embodiments, the upper side panel 227 can at least partially overlap one or both of the lower side panels 155, 159.

In addition, the attachment end flaps 243, 247 can be positioned in at least partial face-to-face contact with respective portions of the respective lower side panels 131, 135, the attachment end flaps 255, 259 can be positioned in at least partial face-to-face contact with respective portions of the lower side panels 127, 123, the attachment end flap 239 can be positioned in at least partial face-to-face contact with the lower end panel 143, and the attachment end flap 139 can be positioned in at least partial face-to-face contact with end flap 239.

It will be understood that the aforementioned arrangement of the tray 100 can be at least partially maintained via one or more applications of an adhesive, such as glue, to a surface of one or more of the respective panels and end flaps thereof.

The bottom panel 121 of the tray 100 can at least partially form a bottom wall 109 thereof. In some embodiments, one or both of the attachment end flaps 251, 260 can additionally form the bottom wall 109.

The panels 123, 127, 131, 135, 147, 151, 155, 159, 227, 231 and end flaps 163, 169, 175, 179, 235, 239, 243, 247, 255, 259 of the tray 100 can cooperate to form a sidewall 111 of the tray 100 extending upwardly from the bottom wall 109 and at least partially around the interior 107 of the tray 100.

The flange panel 221 can at least partially form a rim or flange 113 of the tray 100 extending outwardly from the sidewall 111, e.g., away from the interior 107 of the tray 100 and so as to protrude from respective portions of the sidewall 111. In some embodiments, one or more of the top end flaps 163, 169, 175, 179 can additionally form the flange 113.

As shown, the arrangement of the lower side panels 155, 159 and the upper side panel 227 can at least partially form a recessed portion 115 of the sidewall 111 from the perspective of an exterior of the tray 100, and a corresponding protruding portion 117 into the interior 107 of the tray 100. In some embodiments, the stacking feature 279 can form at least a portion of the protruding portion 117 of the sidewall 111.

Similarly, the arrangement of the lower side panels 147, 151 and the upper side panel 231 can at least partially form a recessed portion 118 of the sidewall 111 from the perspective of an interior 107 of the tray 100, and a corresponding protruding portion 119 from the perspective of the exterior of the sidewall 111 of the tray 100.

Furthermore, the arrangement of the lower side panels 123, 147 and the end flap 255 can at least partially form a recessed portion 122 of the sidewall 111 from the perspective of an exterior of the tray 100, and a corresponding protruding portion 124 into the interior 107 of the tray 100. In some embodiments, the stacking feature 281 can form at least a portion of the protruding portion 124 of the sidewall 111.

Similarly, the arrangement of the lower side panels 127, 151 and the end flap 259 can at least partially form a recessed portion 126 of the sidewall 111 from the perspective of an exterior of the tray 100, and a corresponding protruding portion 128 into the interior 107 of the tray 100. In some embodiments, the stacking feature 283 can form at least a portion of the protruding portion 128 of the sidewall 111.

The physical interaction and connection between the panels to form the sidewall structure may be achieved through a multi-layered assembly process that creates structural cooperation between the upper and lower constructs. The lower side panels 123, 127, 131, 135 may be folded upwardly from the bottom panel 121 to establish the primary sidewall framework. The oblique lower side panels 147, 151, 155, 159 may be folded at their respective oblique fold lines 149, 153, 157, 161 to create angled transitions that extend inwardly toward the interior 107 of the tray 100.

The upper side panels 227, 231 may be positioned to extend downwardly from the flange panel 221 and may be inserted between pairs of the oblique lower side panels. The upper side panel 231 may be positioned between the lower side panels 147, 151, while the upper side panel 227 may be positioned between the lower side panels 155, 159.

The attachment end flaps 243, 247, 251, 255, 259, 260 may extend downwardly from the flange panel 221 and the upper side panels 227, 231 to establish contact surfaces with the lower construct components. The attachment end flaps 251, 260 may be positioned in face-to-face contact with portions of the bottom panel 121, creating a mechanical connection between the upper and lower constructs. The attachment end flaps 243, 247 may be positioned against the lower side panels 131, 135, while the attachment end flaps 255, 259 may be positioned against the lower side panels 123, 127.

The cooperation between panels may be maintained through adhesive bonding applied to the contact surfaces between the upper and lower construct components. The flange panel 221 may be positioned such that its interior surface contacts the top end flaps 163, 169, 175, 179 of the lower construct, creating a horizontal bonding interface. This horizontal interface may distribute structural loads across the assembled sidewall while maintaining the relative positions of the cooperating panels.

The oblique angles of the lower side panels 147, 151, 155, 159 may create recessed and protruding portions 115, 117, 118, 119, 122, 124, 126, 128 in the sidewall 111 that may interlock with corresponding features of the upper construct. The upper side panels 227, 231 may follow the angular profiles established by the oblique lower side panels, creating a continuous sidewall surface that transitions smoothly between the different panel layers.

The end panels 139, 143 may extend upwardly from the bottom panel 121 to provide structural support at the longitudinal ends of the tray 100. The top end flaps 175, 179 may extend outwardly from these end panels to provide additional bonding surfaces for the flange panel 221. This arrangement may create a closed perimeter where the sidewall panels cooperate to fully enclose the interior 107 of the tray 100.

The stacking features 279, 281, 283 may be formed through the cooperation of specific panel combinations that create protruding portions extending into the opening 223. The stacking feature 279 may be formed by the cooperation of the lower side panels 155, 159 with the upper side panel 227 and the oblique inner free edges 263, 277 of the flange panel 221. The stacking features 281, 283 may be formed by the cooperation of the lower side panels 123, 147 and 127, 151 respectively with the attachment end flaps 255, 259 and portions of the flange panel 221.

The interior surface of the tray 100 may be structurally formed through the cooperative arrangement of the bottom panel 121 and the sidewall 111, where these components may work together to define the physical boundaries and transitions that establish the complete interior containment space. Each of the stacking features may comprise a protuberance that extends partially along the interior surface of the tray and that is arranged to support at least a portion of the flange panel. The protuberance may extend towards a central region of the cavity of the tray. The bottom panel 121 may serve as the foundational horizontal surface that may establish the base plane of the interior surface, while the sidewall 111 may extend upwardly from the perimeter edges of the bottom panel 121 to create the vertical boundaries of the interior surface.

The structural cooperation between the bottom panel 121 and sidewall 111 may be achieved through the folding and positioning of the lower side panels 123, 127, 131, 135 at their respective fold lines 125, 129, 133, 137. These lower side panels may be folded upwardly from the bottom panel 121 to establish the primary vertical components of the sidewall 111. The transition zones between the bottom panel 121 and the sidewall 111 may be defined by these fold lines, which may create distinct angular boundaries where the horizontal bottom surface may meet the vertical sidewall surfaces.

The oblique lower side panels 147, 151, 155, 159 may contribute to the interior surface formation by creating angled transitions that may extend inwardly from the primary sidewall structure. These oblique panels may be folded at their respective oblique fold lines 149, 153, 157, 161 to create angular surfaces that may modify the interior geometry. The cooperation between these oblique panels and the bottom panel 121 may establish recessed and protruding portions 115, 117, 118, 119, 122, 124, 126, 128 that may form part of the interior surface contour.

The upper side panels 227, 231 extend downwardly from the flange panel 221 to complete the sidewall structure. These upper side panels may be positioned between pairs of the oblique lower side panels, creating a multi-layer sidewall construction where the upper panels may bridge the gaps between the lower panel arrangements. The attachment end flaps 251, 260 may extend from the upper side panels 227, 231 to make direct contact with the bottom panel 121, establishing physical connections that may integrate the upper and lower constructs into a unified interior surface structure.

The end panels 139, 143 may extend upwardly from the bottom panel 121 at the longitudinal fold lines 141, 145 to form the longitudinal boundaries of the interior surface. These end panels may cooperate with the bottom panel 121 to create the closed perimeter that may define the complete interior containment space. The top end flaps 163, 169, 175, 179 may extend outwardly from the respective side and end panels to provide additional structural elements that may contribute to the overall interior surface definition.

The physical boundaries of the interior surface may be established where the bottom panel 121 may meet the various sidewall components at their respective fold lines. The lateral fold lines 125, 129, 133, 137 may define the primary transition boundaries between the horizontal bottom surface and the vertical sidewall surfaces. The longitudinal fold lines 141, 145 may establish the transition boundaries between the bottom panel 121 and the end panel components of the sidewall 111.

The structural transitions within the interior surface may be created through the angular relationships between the cooperating panels. The oblique fold lines 149, 153, 157, 161 may create angled transitions that may deviate from perpendicular relationships, establishing sloped surfaces that may connect the bottom panel 121 to the sidewall components at non-right angles. These oblique transitions may create stepped or terraced interior surface features that may provide functional benefits for article containment.

The cooperation between the bottom panel 121 and sidewall 111 may be maintained through adhesive bonding applied to the contact surfaces between the various panel components. The attachment end flaps 251, 260 may be positioned in face-to-face contact with portions of the bottom panel 121, creating mechanical connections that may secure the upper construct components to the lower construct. This bonding arrangement may ensure that the cooperative relationship between the bottom panel 121 and sidewall 111 may be maintained throughout the service life of the tray 100.

The interior surface may be further defined by the integration of the stacking features 279, 281, 283 that may extend into the opening 223 of the flange panel 221. These stacking features may be formed through the cooperation of specific sidewall panel combinations with the bottom panel 121, creating protruding portions that may extend into the interior space while maintaining the overall structural integrity of the interior surface boundaries.

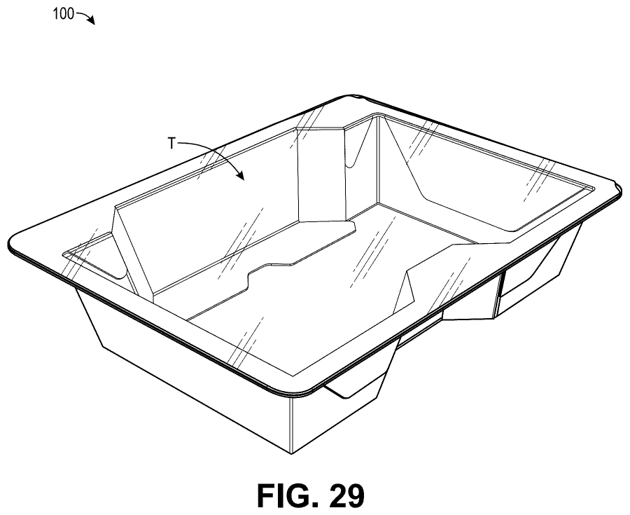

With momentary reference to FIG. 29, in some embodiments, a lid/lid structure such as a lidding film T can comprise packaging film that is a thin plastic layer used to preserve and protect one or more articles contained in the tray 100 and can be removably attached to the flange 113 of the tray 100, e.g., defined by a portion of the flange panel 221. Such a lidding film T can cover the flange 113 of the tray 105 so as to cover the interior 107 of the tray 100. In some embodiments, a hermetic seal of the interior 107 of the tray 100 can be achieved by such engagement by a lidding film T.

Any plastic film, such as polyethylene, polypropylene, polyethylene terephthalate, polyvinylchloride, polyamide, and ethylene vinyl alcohol, or other suitable material, can be used for forming the lidding film that is sealed against the sealing surface of the flange 113/flange panel 221. Further, adhesives can be used between the lidding film and the sealing surface of the flange/central panel without departing from the disclosure.

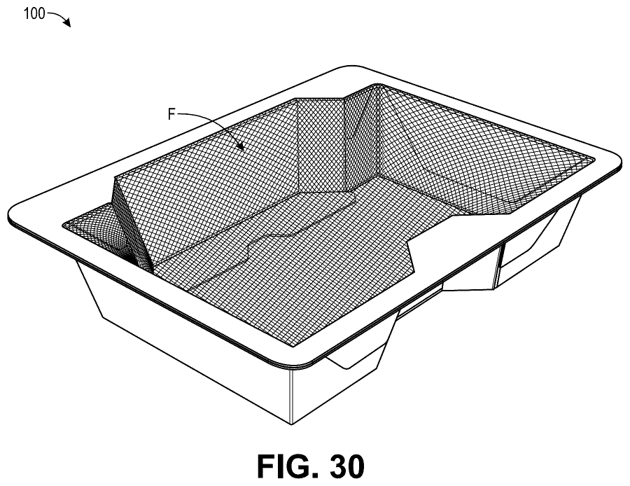

With reference to FIG. 30, it will be understood that, in embodiments, a liner such as liner F can be applied to at least the interior 107 of the tray 100, and can overlie seams/points of intersection between the respective panels, e.g., such that the tray 100 has leak-resistant properties. The tray 105 is illustrated with the liner F applied to one or more interior surfaces thereof in FIG. 30. The liner F can be separably connected to one or more surfaces of the tray 100 along the interior 107 thereof, for example, so that the liner F and tray 105 can be separately disposed of after use.

In this regard, the separable arrangement of the tray 100 and the liner F can facilitate the separate reuse, renewal, recycling, etc. of the paperboard material that forms the tray 100 and the polymeric material that forms the liner F, without commingling thereof.

In some embodiments, a tray 100 can be provided with both a lidding film T and a liner F.

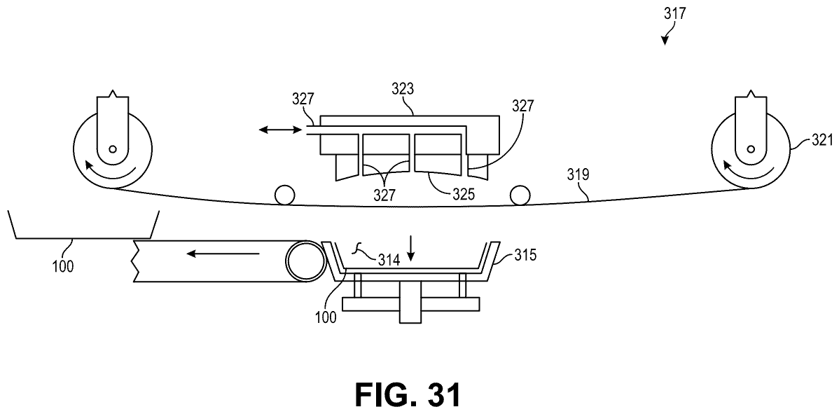

In an embodiment shown schematically in FIG. 31, the tray 100 can be placed on a lower die 315 of a system 317 and a liner material or film sheet 319 from which the liner F is formed can be fed from a supply roller 321 above the tray 100. An upper die 323 has a heater plate surface 325 having a PTFE coating, for example a Teflon® coating. Alternatively, the heater plate surface 325 could have a coating of any suitable material or the coating could be omitted. In some embodiments, an intermediate construction of the tray 100, for example the blank 103/lower construct 105 formed therefrom and/or the blank 203/upper construct 205 formed therefrom can be processed through the system 317 as described herein.

In some embodiments, the film sheet 319 can be a liner comprised of polyethylene, a polyethylene terephthalate (PET) material, or any other thermoplastic material, or a bioplastic, such as vegetable oil or starch based plastics. In one embodiment, such liner can comprise polyethylene that can be softened and fused to the tray 100. In an alternative embodiment, a liner for being attached to the tray 100 can comprise PET or a similar material that is at least partially attached to the tray 100 by a heat seal layer (e.g., a thermoformable sealant grade transparent polyester packaging film, such as Mylar® XMPOL12 available from DuPont Teijin Films U.S. Limited Partnership of Hopewell, Virginia, or any suitable thermoformable sealant or adhesive, any suitable heat or pressure activated adhesive, or any other suitable material), wherein a PET liner can be more suitable for uses that require heating of the container in an oven.

As schematically shown in FIG. 31, the upper die 323 can include a plurality of holes or ducts 327 in the heater plate surface 325 for applying a vacuum and/or air pressure on the sheet 319. The lower die 315 and/or the upper die 323, including the ducts 327 and/or the heater plate 325, could be otherwise shaped, arranged, positioned, and/or configured without departing from the disclosure. For example, the heater plate 325 could be omitted and the heat could be alternatively applied to the sheet 319 (e.g., with a flow of hot air).

In the illustrated embodiment, the lower die 315 can hold the tray 100 over a cavity 314 in the lower die 315 while supporting the tray 100 so that the flange panel 221 is facing upwardly). An initial vacuum can be applied to ducts 327 to draw the film sheet 319 toward the upper die 323, the upper die 323 can be heated to a suitable temperature to soften the film sheet 319 and/or to activate a heat seal layer. Instead of, or in addition to, the initial vacuum, air pressure under the film sheet 319 can be employed with similar or equal effect. Subsequently, the film sheet 319 can be forced downwardly (e.g., by air pressure applied by the ducts 327 and/or a vacuum applied from below the tray 100).

The air pressure can move the film sheet 319 toward the tray 100 and the lower die 315 can support the blanks 103, 203/tray 105 as the film sheet 319 is applied to overlie exposed portions of the panels 123, 127, 131, 135, 147, 151, 155, 159, 227, 231 and end flaps 163, 169, 175, 179, 235, 239, 243, 247, 255, 259 therealong to form the liner F. In some embodiments, the film sheet 315 can additionally be applied to the flange panel 221.

In some embodiments, the liner F can help retain the tray 100 in its tray shape after the liner F is applied to the tray 100. For example, in some embodiments, the attachment of the liner F to the tray 100 can at least partially maintain the position of the panels 123, 127, 131, 135, 147, 151, 155, 159, 227, 231 and end flaps 163, 169, 175, 179, 235, 239, 243, 247, 255, 259 of the tray 100 relative to one another.

In some embodiments, the tray 100 can be ejected from the lower die 315 and transported away from the forming tool on a conveyor for further or final processing, for example.

In some embodiments, the tray 100 can be formed from the blank 103 and have the liner F applied thereto at a much higher rate than systems that separately form the tray 100 from the blanks 103, 203 and then place that formed tray 100 into the lower die 315. In one example, the tray 100 of the present embodiment can be formed from the blank 103 together with the liner F at a rate of approximately 200 trays per minute. The tray 100 could be otherwise formed without departing from the disclosure.

It will be understood that the liner F can be provided in combination with one or both of the blanks 103, 203 for forming the tray 100.

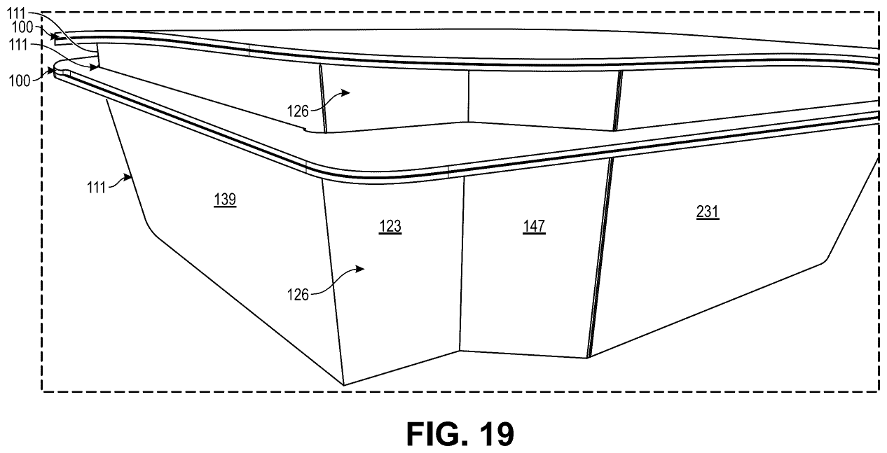

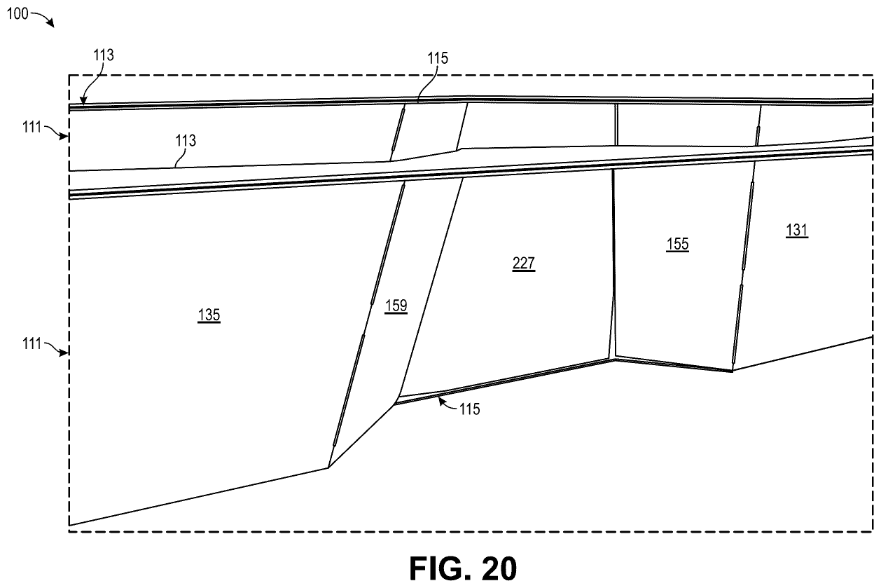

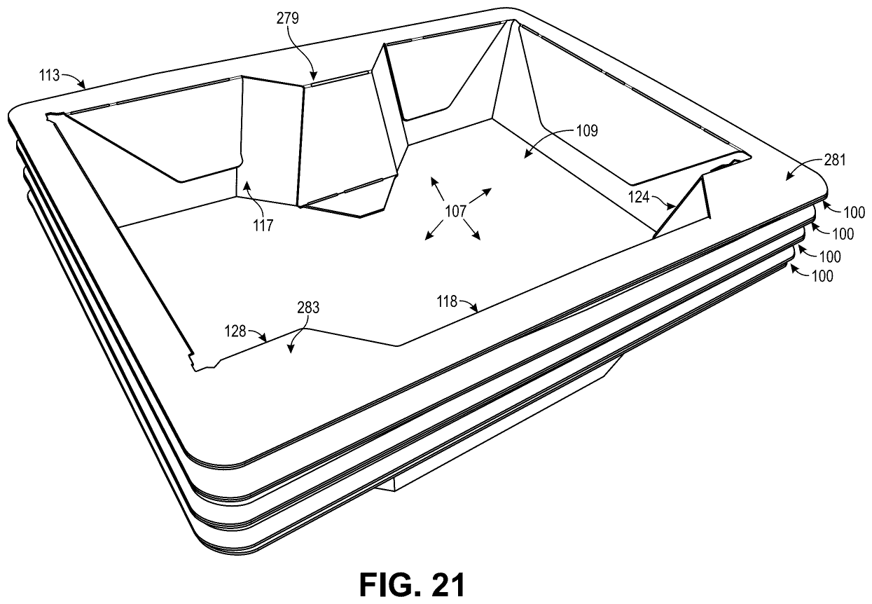

With additional reference to FIGS. 19-21, multiple trays 100 can be provided in nesting arrangements in which the sidewall 111 and bottom wall 109 of an upper tray 100 can be at least partially received in the interior 107 of a lower tray 100. Multiple upper and lower trays 100 can thus be nested in such a fashion, for example, for shipping, storage, other space saving situations, etc.

As shown, such nesting arrangements of multiple trays 100 can be facilitated, in some embodiments, by the engagement of respective protruding and recessed portions of the respective sidewall 111 of the trays 100.

For example, the recessed portions 115, 122, 126 of the sidewall 111 of an upper tray 100 can be arranged in the interior 107 of a lower tray 100 such that the protruding portions 117, 124, 128 of the lower tray 100 are arranged in abutting relation with the recessed portions 115, 122, 126 of the upper tray 100. Such engagement of respective protruding and recessed portions of a respective sidewall 111 between vertically-adjacent or nested trays can contribute to a close, space saving nested arrangement of trays 100 that can also avoid unwanted relative movement therebetween.

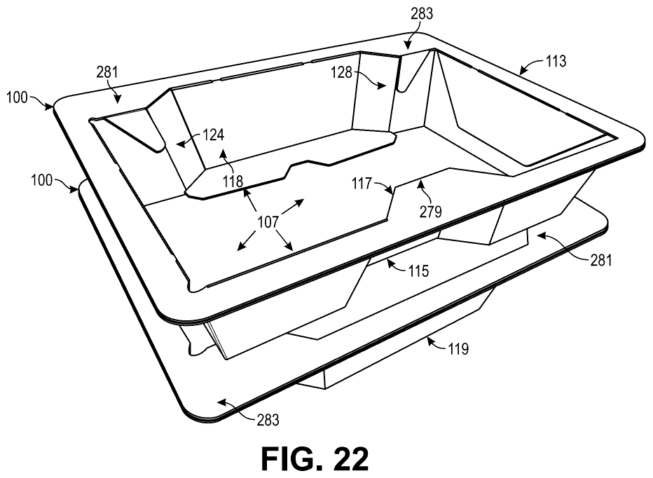

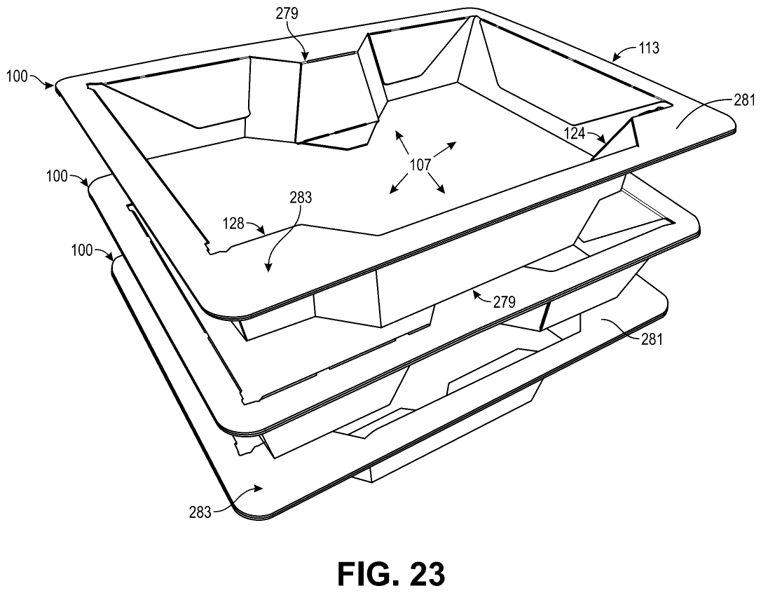

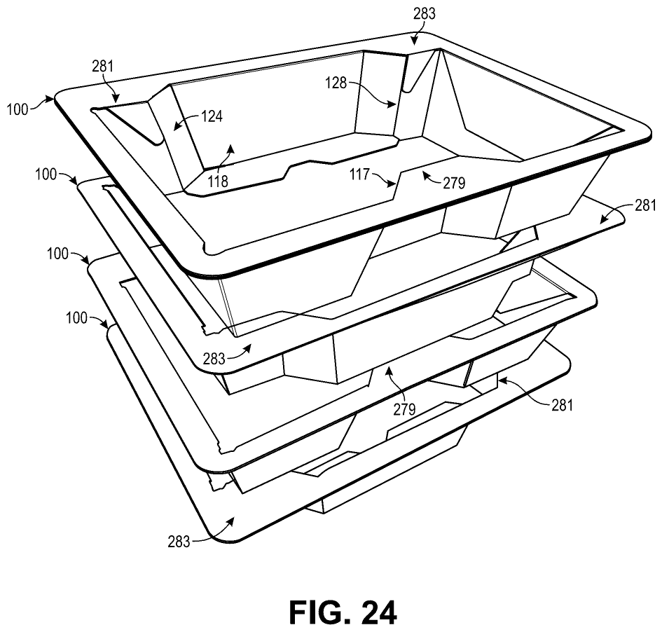

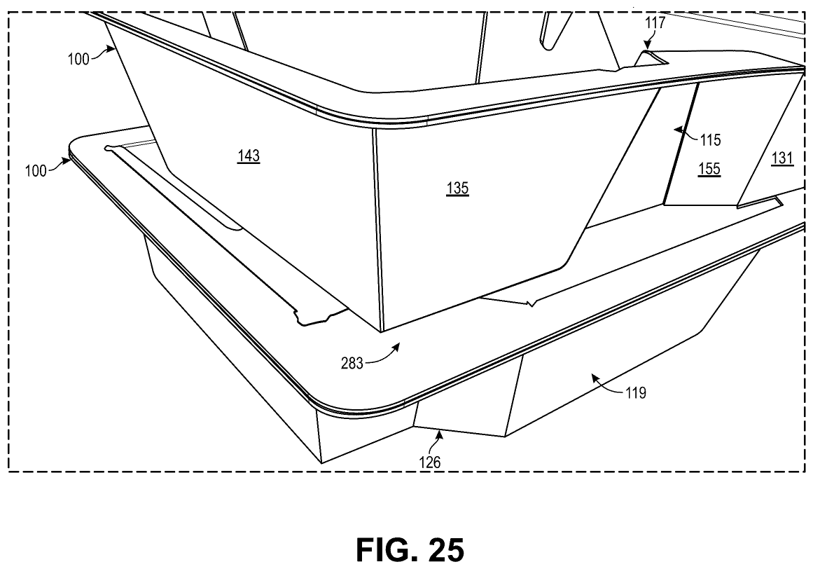

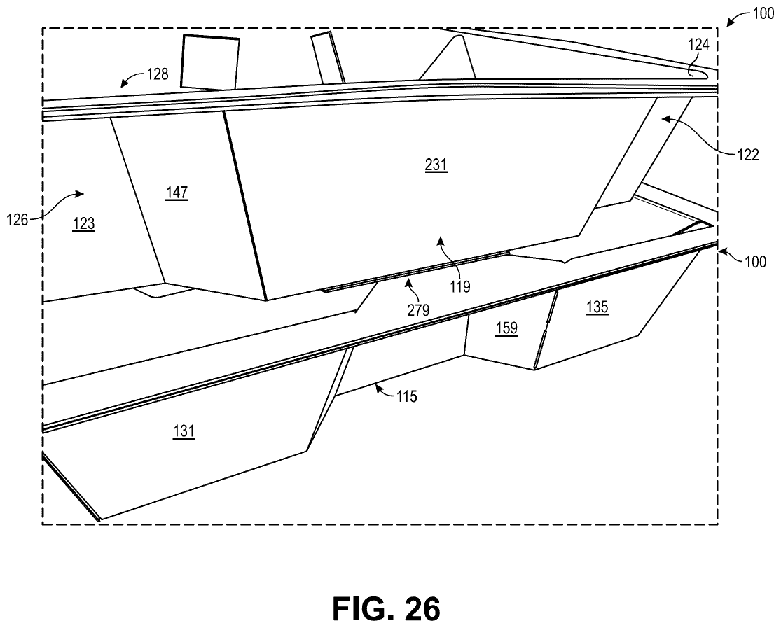

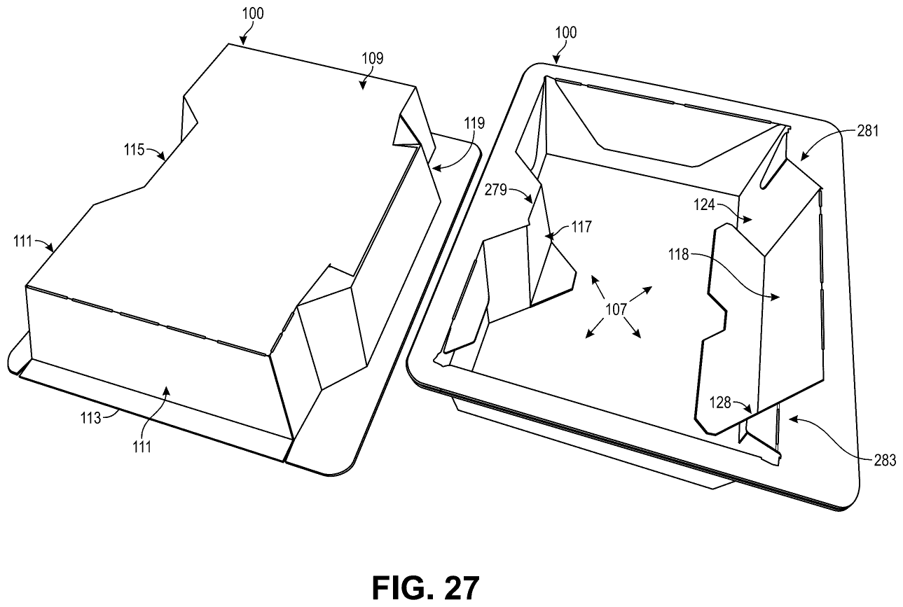

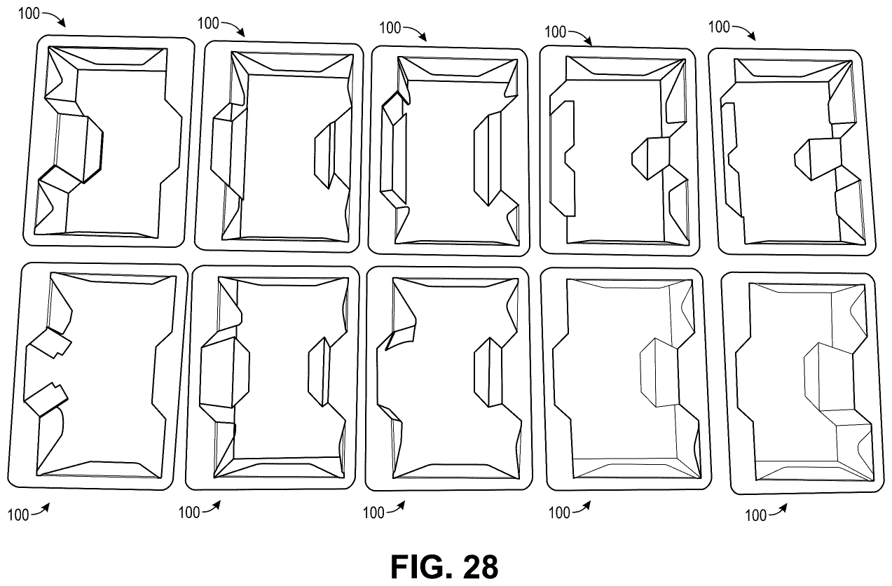

With additional reference to FIGS. 22-26, the stacking features of the tray 100 can facilitate stacking of multiple trays 100, for example, for display, during food service, for accessibility, etc.

As shown, an upper tray 100 can be stacked upon a lower tray 100 by positioning the upper tray 100 at an orientation of about 180 degrees measured about an axis perpendicular to the bottom wall 109/bottom panel 121 of the lower tray 100 (e.g., a vertical axis perpendicular to each of the lateral axis L1 and the longitudinal axis L2) relative to the lower tray 100 such that the bottom wall 109 of the upper tray 100 is positioned to rest upon the respective stacking features 279, 281, 283 of the lower tray 100.

In this regard, the bottom wall 109/bottom panel 121 of the upper tray 100 can have an outer perimeter that generally follows that of the sidewall 111 thereof, e.g., such that the portions of the bottom wall 109/bottom panel 121 of the upper tray 100 can be positioned to rest upon the respective stacking features 279, 281, 283 along the flange 113 of the lower tray 100.

Such stacked arrangement of a lower tray 100 and an upper tray 100 can be such that the bottom wall 109 of the upper tray 100 is in generally planar and abutting relation with a respective portion of the flange 113 of the lower tray 100.

In some embodiments, the stable stacking arrangement afforded to trays 100, e.g., due to the asymmetrical nature of the respective flanges 113 thereof that define the respective stacking features, can avoid stresses associated with stacking trays upon respective lidding films of trays 100.

The stacking features 279, 281, and 283 may engage mechanically with the bottom wall 109 of a supported tray through direct contact interfaces that distribute load forces across multiple contact points. The first stacking feature 279 may extend into the opening 223 such that its uppermost surface may be positioned to receive and support a corresponding portion of the bottom panel 121 of an upper tray positioned thereon. The protruding geometry of the first stacking feature 279 may create a contact surface where the bottom wall 109 of the supported tray may rest directly upon the stacking feature surface.

The second stacking feature 281 may similarly protrude into the opening 223 to establish a second contact surface with the bottom wall 109 of the supported tray. The positioning of the second stacking feature 281 relative to the first stacking feature 279 may create a distributed support arrangement where load forces from the supported tray may be transmitted through multiple discrete contact locations rather than through a continuous surface interface. The oblique orientation of the free edge 267 and the free edge 269 that at least partially define the second stacking feature 281 may define a contact surface that may engage with corresponding portions of the bottom panel 121.

The third stacking feature 283 may establish a third contact surface with the bottom wall 109 through its protruding configuration into the opening 223. The free edge 271 and the fold line 261 that at least partially define the third stacking feature 283 may create a contact surface geometry that may complement the perimeter shape of the bottom panel 121 of the supported tray. The three-point contact arrangement established by the stacking features 279, 281, and 283 may provide structural stability by creating a triangulated support system that may resist lateral movement of the supported tray.

The load distribution mechanism may function through the transfer of gravitational forces from the supported tray's bottom wall 109 through the contact points established by each stacking feature. The bottom panel 121 of the supported tray may rest upon the uppermost surfaces of the stacking features such that the weight of the supported tray and any contents therein may be transmitted downwardly through the stacking features to the flange panel 221 of the supporting tray. The distributed nature of this load transfer may prevent concentrated stress points that might otherwise cause deformation of either the supporting or supported tray structures.

In this regard, the trays 100 are orientable relative to like upper and lower trays between a first, nesting, orientation, in which a tray 100 is in a generally similar orientation to an upper tray and/or a lower tray to facilitate a nesting arrangement, and a second, stacking orientation, in which a tray 100 is rotated about 180 degrees about a vertical axis relative to an upper tray and/or a lower tray to facilitate a stacking arrangement along respective stacking features on a flange thereof.

The stacking features 279, 281, 283 may be formed through the specific structural interactions between the upper and lower construct panels when the tray 100 is assembled. The first stacking feature 279 may be created by the positioning of the lower side panels 155, 159 in relation to the upper side panel 227 and the configuration of the flange panel 221. When the upper side panel 227 is positioned between the lower side panels 155, 159 during assembly, the resulting arrangement may form a recessed portion 115 of the sidewall 111 from the exterior perspective and a corresponding protruding portion 117 extending into the interior 107 of the tray 100. The free edges 263, 277 of the flange panel 221 may define the boundaries of this first stacking feature 279, creating a portion of the flange panel 221 that protrudes relative to adjacent portions thereof into the opening 223.

The second stacking feature 281 may be formed through the interaction of the lower side panels 123, 147 with the attachment end flap 255. The positioning of the attachment end flap 255 in face-to-face contact with respective portions of the lower side panel 123 may create a recessed portion 122 of the sidewall 111 from the exterior perspective and a corresponding protruding portion 124 extending into the interior 107. The free edge 267, fold line 257, and free edge 269 of the flange panel 221 may cooperatively define this second stacking feature 281, with the fold line 257 serving as a structural transition point where the attachment end flap 255 connects to the flange panel 221.

The third stacking feature 283 may be formed similarly through the arrangement of the lower side panels 127, 151 with the attachment end flap 259. The positioning of the attachment end flap 259 in face-to-face contact with respective portions of the lower side panel 127 may create a recessed portion 126 of the sidewall 111 from the exterior perspective and a corresponding protruding portion 128 extending into the interior 107. The free edge 271, fold line 261, and at least a portion of the free edge 269 of the flange panel 221 may define this third stacking feature 283, with the fold line 261 providing the structural connection between the attachment end flap 259 and the flange panel 221.

Each stacking feature may be characterized by the specific geometric relationship between the flange panel 221 and the underlying panel arrangements from both constructs. The oblique free edges 263, 269, 271, 277 of the flange panel 221 may create angular transitions that form the protruding portions extending into the opening 223. The fold lines 257, 261 may serve as pivot points where the attachment end flaps 255, 259 transition from the flange panel 221 to their respective positions against the lower construct panels. The right angled inner free edges 265, 267, 273, 275 of the flange panel 221 may provide structural boundaries that define the extent of each stacking feature.

The adhesive bonding between the upper and lower constructs may maintain the relative positions of these panels, thereby preserving the geometric configuration that creates each stacking feature. The face-to-face contact between the attachment end flaps 255, 259 and their respective lower side panels 123, 127 may establish the structural foundation for the protruding portions 124, 128 that form parts of the stacking features 281, 283. The positioning of the upper side panel 227 between the lower side panels 155, 159 may similarly establish the structural foundation for the protruding portion 117 that forms part of the stacking feature 279.

Any of the features of the various embodiments of the disclosure can be combined with, replaced by, or otherwise configured with other features of other embodiments of the disclosure without departing from the scope of this disclosure.

In general, the blank may be constructed from paperboard having a caliper so that it is heavier and more rigid than ordinary paper. The blank can also be constructed of other materials, such as cardboard, or any other material having properties suitable for enabling the carrier to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carrier embodiments. The term “glue” is intended to encompass all manner of adhesives commonly used to secure carrier panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A tray for holding one or more articles, the tray comprising:
an upper construct comprising a plurality of upper panels, the plurality of upper panels comprising a flange panel extending at least partially around an opening and at least partially forming a flange of the tray;
a lower construct comprising a plurality of lower panels, the plurality of lower panels comprising a bottom panel at least partially forming a bottom wall of the tray and a plurality of lower side panels at least partially forming a sidewall extending at least partially around an interior of the tray; and
stacking features at least partially defined along the flange of the tray and extending into the opening for supporting another tray thereon.

2. The tray of claim 1, wherein the stacking features include a first, a second and a third stacking feature.

3. The tray of claim 1, wherein the plurality of upper panels include a plurality of upper side panels foldably connected to the flange panel and wherein the plurality of lower side panels are foldably connected to the bottom wall.

4. The tray of claim 3, wherein at least some of the plurality of lower panels cooperate with at least some of the plurality of upper side panels to form the sidewall.

5. The tray of claim 3, wherein a first stacking feature is formed by two second side lower side panels of the plurality of lower side panels, an upper side panel of the plurality of upper side panels, and a free edge of the flange panel.

6. The tray of claim 3, wherein each of the second and third stacking features are formed by two first side lower side panels of the plurality of lower side panels and an upper side panel end flap of the plurality of upper side panels.

7. The tray of claim 3, wherein the bottom panel and the sidewall cooperate to define an interior surface of the tray and wherein the sidewall cooperates with the flange panel to define the stacking features.

8. The tray of claim 7, wherein each stacking feature includes a protuberance extending at least partially along the interior surface of the tray.

9. The tray of claim 3, wherein the plurality of upper side panels extend at an oblique angle from the flange panel and wherein the plurality of lower side panels extend at an oblique angle from the bottom wall.

10. A combination of blanks for forming a tray, the combination of blanks comprising:
an upper blank comprising a plurality of upper panels, the plurality of upper panels comprising a flange panel extending at least partially around an opening and at least partially forming a flange of the tray;
a lower blank comprising a plurality of lower panels, the plurality of lower panels comprising a bottom panel configured to at least partially form a bottom wall of the tray and a plurality of lower side panels configured to at least partially form a sidewall extending at least partially around an interior of the tray; and
stacking features at least partially defined along the flange of the tray and extending into the opening for supporting another tray thereon.

11. The combination of blanks of claim 10, wherein the stacking features comprise a first, a second and a third stacking feature.

12. The combination of blanks of claim 10, wherein the plurality of upper panels include a plurality of upper side panels foldably connected to the flange panel and wherein the plurality of lower side panels are foldably connected to the bottom wall.

13. The combination of blanks of claim 12, wherein at least some of the plurality of lower side panels are configured to cooperate with at least some of the plurality of upper side panels to form the sidewall.

14. The combination of blanks of claim 12, wherein a first stacking feature is formed by two second side lower side panels of the plurality of lower side panels, an upper side panel of the plurality of upper side panels, and a free edge of the flange panel.

15. The combination of blanks of claim 12, wherein each of the second and third stacking features are formed by two first side lower side panels of the plurality of lower side panels and an upper side panel end flap of the plurality of upper side panels.

16. The combination of blanks of claim 12, wherein the bottom panel and the sidewall are configured to cooperate to define an interior surface of the tray and wherein the sidewall is configured to cooperate with the flange panel to form the stacking features.

17. The combination of blanks of claim 16, wherein each stacking feature includes a protuberance extending at least partially along the interior surface of the tray.

18. The combination of blanks of claim 12, wherein the plurality of upper side panels are configured to extend at an oblique angle from the flange panel and wherein the plurality of lower side panels are configured to extend at an oblique angle from the bottom wall.

19. A method of forming a tray, the method comprising:
obtaining an upper blank comprising a plurality of upper panels, the plurality of upper panels comprising a flange panel extending at least partially around an opening and stacking features extending into the opening;
obtaining a lower blank comprising a plurality of lower panels that comprise a bottom panel and a plurality of lower side panels; and
forming an upper construct from the upper blank to form a flange of the tray and forming a lower construct from the lower blank such that the bottom panel at least partially forms a bottom wall of the tray and such that the plurality of lower side panels at least partially form a sidewall of the tray, and such that the stacking features are arranged along the flange of the tray for at least partially supporting another tray thereon.

20. The method of claim 19, wherein the stacking features include a first, a second and a third stacking feature.

21. The method of claim 19, wherein the plurality of upper panels include a plurality of upper side panels foldably connected to the flange panel and wherein the plurality of lower side panels are foldably connected to the bottom wall.

22. The method of claim 21, wherein at least some of the plurality of lower side panels cooperate with at least some of the plurality of upper side panels to form the sidewall.

23. The method of claim 21, wherein a first stacking feature is formed by two second side lower side panels of the plurality of lower side panels, an upper side panel of the plurality of upper side panels, and a free edge of the flange panel.

24. The method of claim 21, wherein each of the second and third stacking features are formed by two first side lower side panels of the plurality of lower side panels and an upper side panel end flap of the plurality of upper side panels.

25. The method of claim 21, wherein the bottom panel and the sidewall cooperate to define an interior surface of the tray and wherein the sidewall cooperates with the flange panel to define the stacking features.

26. The method of claim 25, wherein each stacking feature includes a protuberance extending at least partially along the interior surface of the tray.

27. The method of claim 21, wherein the plurality of upper side panels extend at an oblique angle from the flange panel and wherein the plurality of lower side panels extend at an oblique angle from the bottom wall.

28. A stack of trays for holding one or more food products, the stack of trays comprising:
an upper tray; and
a lower tray at least partially supporting the upper tray, the lower tray comprising:
an upper construct comprising a plurality of upper panels, the plurality of upper panels comprising a flange panel extending at least partially around an opening and at least partially forming a flange of the lower tray;
a lower construct comprising a plurality of lower panels comprising a bottom panel at least partially forming a bottom wall of the lower tray and a plurality of lower side panels at least partially forming a sidewall extending at least partially around an interior of the lower tray; and
stacking features at least partially defined along the flange of the tray and extending into the opening for at least partially supporting the upper tray.

29. The stack of trays of claim 28, wherein the stacking features include a first stacking feature, a second stacking feature, and a third stacking feature.

30. The stack of trays of claim 28, wherein the plurality of upper panels include a plurality of upper side panels foldably connected to the flange panel and wherein the plurality of lower side panels are foldably connected to the bottom wall.

31. The stack of trays of claim 30, wherein at least some of the plurality of lower side panels cooperate with at least some of the plurality of upper side panels to form the sidewall.

32. The stack of trays of claim 30, wherein a first stacking feature is formed by two second side lower side panels of the plurality of lower side panels, an upper side panel of the plurality of upper side panels, and a free edge of the flange panel.

33. The stack of trays of claim 30, wherein each of the second and third stacking features are formed by two first side lower side panels of the plurality of lower side panels and an upper side panel end flap of the plurality of upper side panels.

34. The stack of trays of claim 30, wherein the bottom panel and the sidewall cooperate to define an interior surface of the lower tray and wherein the sidewall cooperates with the flange panel to define the stacking features.
